(19) United States
(12) Patent Application Publication
(10) Pub. No.: US 2022/0104512 A1
(43) Pub. Date: Apr. 7, 2022

(54) A CONFECTIONARY DECORATING KIT

(71) Applicants: Amy COYLE, Naas (IE); Paul COYLE, Naas (IE)

(72) Inventors: Amy COYLE, Naas (IE); Paul COYLE, Naas (IE)

(21) Appl. No.: 17/427,735

(22) PCT Filed: Feb. 1, 2019
(86) PCT No.: PCT/EP2019/052535

§ 371 Date: Aug. 2, 2021

(51) Int. Cl. A23G 3/28; A23G 3/02; B41K 1/36

(52) U.S. Cl. CPC A23G 3/28; B41K 1/363; A23G 3/0247

(57) ABSTRACT

A confectionary decorating kit comprising a block comprising a plurality of decorative stamp elements and a plurality of receptacles defined in the block wherein each decorative stamp element is mounted into a matching receptacle, and wherein each decorative stamp element is removable from its matching receptacle. In addition a confectionary decorating kit comprising a plate comprising a first plate surface wherein a decorative stamp element is attachable to the first plate surface of the plate to form a decorative stamp comprising a design formed from the decorative stamp elements, and wherein the decorative stamp is for use to imprint the design into an item of edible confectionary.

### FIELD OF THE INVENTION

The present invention relates to a confectionary decorating kit, more particularly a kit for imprinting designs into items of confectionary.

### BACKGROUND TO THE INVENTION

A standard practice in the preparation of confectionary is the decoration of confectionary to enhance the appearance of the confectionary. This can be accomplished by imprinting a design into the confectionary.

A method known in the prior art to achieve decoration on confectionary such as fondant (sugar paste) was to use tracing paper to outline the lettering and then paint. This requires a high level of skill. An alternative method for decorating confectionary is cutting the shape of letters out of fondant and sticking them to the cake to form the required design.

It is known in the art to use decorative stamps to imprint designs into confectionary. However standard decorative stamps are provided with a single design and to create a new design a new stamp must be manufactured.

### SUMMARY OF THE INVENTION

In one aspect, the present invention provides a confectionary decorating kit comprising:

a block comprising a plurality of decorative stamp elements and a plurality of receptacles defined in the block wherein each decorative stamp element is mounted into a matching receptacle, and

wherein each decorative stamp element is removable from its matching receptacle.

Advantageously the kit of the present invention provides a plurality of decorative stamp elements which can be removed from their matching receptacles and used to decorate confectionary. As individual decorative stamp elements may be selected the kit of the present invention allows the user to create new designs formed from the decorative stamp elements without the need to manufacture a new stamp for each individual design. Advantageously the kit of the present invention is adaptable to form new designs as required by the user.

In the kit of the present invention desirably the kit comprises a backing, for example a supporting layer attached to and beneath the block. Beneficially a backing attached to and beneath the block adds stability to the block. Beneficially the backing beneath the block provide a retaining means preventing the decorative stamp elements from passing through the matching receptacles. Beneficially this allows the kit to be stored easily reducing the risk of the decorative stamp elements falling from the matching receptacles. The backing may be formed from a polymer, for example acrylic.

In one aspect the kit of the present invention provides a plate comprising a first plate surface, wherein a decorative stamp element is attachable to the first plate surface of the plate to form a decorative stamp comprising a design formed from the decorative stamp elements, and wherein the decorative stamp is for use to imprint the design into an item of edible confectionary.

Advantageously the kit of the present invention provides a plurality of decorative stamp elements which can be removed from their matching receptacles. Decorative stamp elements are, when placed on the plate, together with the plate form a decorative stamp on the first plate surface. As individual decorative stamp elements may be selected and placed on the plate to form a desired decorative stamp, the kit of the present invention allows the user to create new designs formed from the decorative stamp elements without the need to manufacture a new stamp for each individual design. Advantageously the kit of the present invention is adaptable to form new designs as required by the user.

In the confectionary decorating kit of the invention desirably the decorative stamp elements are rigid. Rigid decorative stamp elements allow the confectionary stamp elements of the confectionary decorating kit of the invention to imprint a design into an item of confectionary.

In the confectionary decorating kit of the invention each decorative stamp element desirably comprises a first surface which is an imprinting face, and a side which forms an angle of from 85° to 95°, preferably 90°, with the first surface. Preferably the imprinting face and the side form an angle of from 85° to 95°, preferably about 90°, and desirably all angles formed between the imprinting face and the side(s) of the decorative stamp element are from 85° to 95° for example about 90°. The angle between the first surface and the side of each decorative stamp element means that the decorative stamp elements form a precise indent when used to imprint a design into an item of confectionary. The imprinted design will have an angle corresponding to the angle formed between the imprinting face and the side of the decorative stamp element, the angle of the imprinted design being the angle formed at the point of contact between the decorative stamp element and the item of confectionary into which the decorative stamp is imprinted. The sides of the decorative stamp elements form uniform wall like edges and imprinting face forms a flat bottom bed which allows any paint applied subsequent to imprinting the design to spread evenly and dry uniformly giving a very professional look previously unseen or done in the caking industry. The defined angle formed in the imprinted design controls the flow of edible paint to create an even and precise outcome. If the embossed design does not have the sharp angles from about 85° to 95°, preferably about 90°, and flat bottomed characteristic formed by the first surface which is an imprinting surface the resulting outcome would cause any paint applied subsequent to imprinting the design to pool and or leak away from the desired finish design

Desirably the kit of the invention further comprises a gripper. In the kit of the present invention desirably each decorative stamp element is attachable to a gripper. Beneficially each decorative stamp element being attachable to a gripper allows each decorative stamp element to be removed from its matching receptacle without the possibility of damaging each decorative stamp element.

In the kit of the present invention desirably the gripper comprises a first gripper surface wherein the first gripper surface is attachable to each decorative stamp element.

In the kit of the present invention desirably the gripper comprises a handle. Beneficially the gripper comprising a handle allows the gripper to be easily handled.

In the kit of the present invention desirably each decorative stamp element is attachable to the first gripper surface by adhesive, magnetic, or suction means.

In the kit of the present invention desirably each decorative stamp element is attachable to the first gripper surface by means of pressure sensitive adhesive. Beneficially each decorative stamp element attaching to the first gripper surface by means of pressure sensitive adhesive allows each decorative stamp element to be easily removed from the first gripper surface without damaging each decorative stamp element.

In the kit of the present invention desirably the block is made from plastics. Beneficially the block being made from plastic means that the plurality of decorative stamp elements can be cut from the block. Typically the decorative stamp element is formed by cutting through the entire block. This means that a matching receptacle for the decorative stamp element is formed as a through-hole through the block. Accordingly a decorative stamp element could pass through the block and fall out the other side. With a backing in place it prevents a decorative stamp element from passing through the block. Indeed the backing will typically hold the decorative stamp element flush with the top (and bottom) surface(s) of the block. However constructed it is desirable that each decorative stamp element is a mating fit with its matching receptacle so that when placed in the matching receptacle it is held there and remains in place and for example does not fall out when the block is turned upside down.

In the kit of the present invention desirably the block is made from food grade plastics. Beneficially the block being made from food grade plastics means that the plurality of decorative stamp elements which may comprise the decorative stamp are suitable for contact with confectionary.

In the kit of the present invention desirably the decorative stamp elements are cut from the block for example where the block is laser cut to form the plurality of decorative stamp elements and matching receptacles in the block. Beneficially the decorative stamp elements being cut from the block means that each decorative block element will match the receptacle or cut out defined in the block.

In the kit of the present invention desirably the plate is made from plastics.

In the kit of the present invention desirably the plate is made from food grade plastics. Beneficially the plate being made from food grade plastic means that the plate is suitable for contact with confectionary.

In the kit of the present invention desirably the plate is rigid. Beneficially the plate being rigid allows the decorative stamp to be easily manipulated to the correct orientation to imprint the design into an item of confectionary.

In the kit of the present invention the block may comprise a lever slot defined therein which is contiguous to one of the matching receptacles defined in the block, wherein a lever may be inserted into the lever slot to remove the removable decorative stamp element mounted in the matching receptacle. In the kit of the present invention the block may comprise a plurality of lever slots defined therein wherein each lever slot of the plurality of lever slots is contiguous with an individual matching receptacle. The respective lever slots that are contiguous with each individual matching receptacle are small so as not to prevent the mating fit between each decorative stamp element and its matching receptacle defined in the block. Beneficially the lever slots allow the insertion of a lever, for example a craft knife or a pick such as a toothpick into the lever slot to aid in the removal of the removable decorative stamp element mounted in the matching receptacle.

In the kit of the present invention desirably the plate comprises a raised gripping portion or a handle. Beneficially the plate comprising a raised gripping portion or handle allows the plate to be easily manipulated to the correct orientation to imprint the design into an item of confectionary.

In the kit of the present invention desirably each decorative stamp element is attachable to the first plate surface by adhesive, magnetic, or suction means.

In the kit of the present invention a decorative stamp element is desirably attachable to the first plate surface by means of pressure sensitive adhesive. Beneficially each decorative stamp element attaching to the first plate surface by means of pressure sensitive adhesive allows each decorative stamp element to be easily removed from the first plate surface without damaging each decorative stamp element.

In the kit of the present invention desirably each decorative stamp element typically is in the shape of an alphabetical letter, a number, or a geometric shape. Geometric shapes may include such shapes as curls or swirls, floral shapes, or silhouettes. Beneficially each decorative stamp element being in the shape of an alphabetical letter, number or geometric shape allows the kit of the invention to form a plurality of different decorative stamps wherein each decorative stamp comprises the decorative stamp elements which are selected from the plurality of decorative stamp elements.

In the kit of the present invention desirably the confectionary is a baked good such as a cake, a bun, a pastry, a tart, a cookie or a pie.

In the kit of the present invention desirably the confectionary comprises an outer layer of icing or frosting. Beneficially an outer layer of icing or frosting on the confectionary provides an imprintable layer on the confectionary.

In one aspect the kit of the present invention comprises the block and the plate of the invention. In the kit of the present invention desirably the kit comprises the block, the plate, and the gripper of the invention. Optionally a pick may be provided.

Another aspect of the present invention is a method of decorating confectionary comprising;

removing a decorative stamp element or a plurality of decorative stamp elements from a matching receptacle or receptacles in a block,

and

pressing the decorative stamp onto the edible confectionary to imprint the design onto the confectionary.

The method of decorating confectionary desirably comprises attaching the a decorative stamp element(s) to a first surface of a plate to form a decorative stamp comprising a design formed from the decorative stamp element(s) and pressing the decorative stamp into the edible confectionary to imprint a design into the confectionary.

The method of decorating confectionary desirably comprises attaching the decorative stamp element(s) removed from the block to a first surface of a plate to form a decorative stamp comprising a design formed from the decorative stamp element(s) removed from the block and pressing the decorative stamp into the edible confectionary to imprint a design into the confectionary.

The method of decorating confectionary desirably comprising removing the attached decorative element(s) from the first surface of the plate and replacing each decorative element into the matching receptacle in the block. Beneficially replacing each decorative element into the matching receptacle in the block allows the each decorative element to be safely stored within the block prior to any additional use according to the invention.

The method of decorating confectionary desirably comprises removing each decorative stamp element from the matching receptacle by means of a lever inserted into a lever slot defined in the block. Beneficially the lever slot in the block allows the easy removal of each decorative stamp element from its matching receptacle.

The method of decorating confectionary desirably comprises removing each decorative stamp element from the matching receptacle using a gripper. Beneficially the use of a gripper to remove each decorative stamp element prevents the decorative stamp elements from being damaged when being removed from the matching receptacles.

The method of decorating confectionary desirably wherein the gripper comprises a first gripper surface attaching to the decorative stamp element. Beneficially the first gripper surface attaching to the decorative stamp element allows removal of the decorative stamp elements by use of a gripper.

The method of decorating confectionary desirably wherein attaching each decorative stamp element is achieved by adhesive, magnetic, or suction means.

The method of decorating confectionary desirably wherein attaching each decorative stamp element to the first surface of the plate is achieved by means of pressure sensitive adhesives. Beneficially the attachment of each decorative stamp element to the first surface of the plate by means of pressure sensitive adhesives allows each stamp element to be easily removable from the first surface of the plate.

The method of decorating confectionary desirably comprising removing the decorative stamp element(s) from the matching receptacle(s) in the block and placing the decorative stamp element(s) onto a retaining surface to form the design,

pressing the first surface of the plate onto the removed decorative stamp element(s) thereby attaching the removed decorative stamp element(s) to the first surface of the plate thereby forming the decorative stamp comprising a mirror image of the design, and

pressing the decorative stamp onto the confectionary thereby imprinting the design onto the confectionary.

The method of decorating confectionary desirably wherein the imprinted design is subsequently coloured using edible food dye. Beneficially the imprinted design forms a template which allows the precise application of edible food dye to further enhance the visual appearance of the confectionary.

### BRIEF DESCRIPTION OF THE DRAWINGS

Embodiments of the invention will be described, by way of example only, with reference to the accompanying drawings in which:

FIG. 1 is an embodiment of the block of the invention;

FIG. 2 is an embodiment of the block of the invention;

FIG. 3 is an embodiment of the plate of the invention;

FIG. 4 is an embodiment of the application of a design to confectionary of the invention

FIG. 5 is an embodiment of the gripper of the invention.

FIG. 6 is an embodiment of a design which has been imprinted and coloured according to the invention.

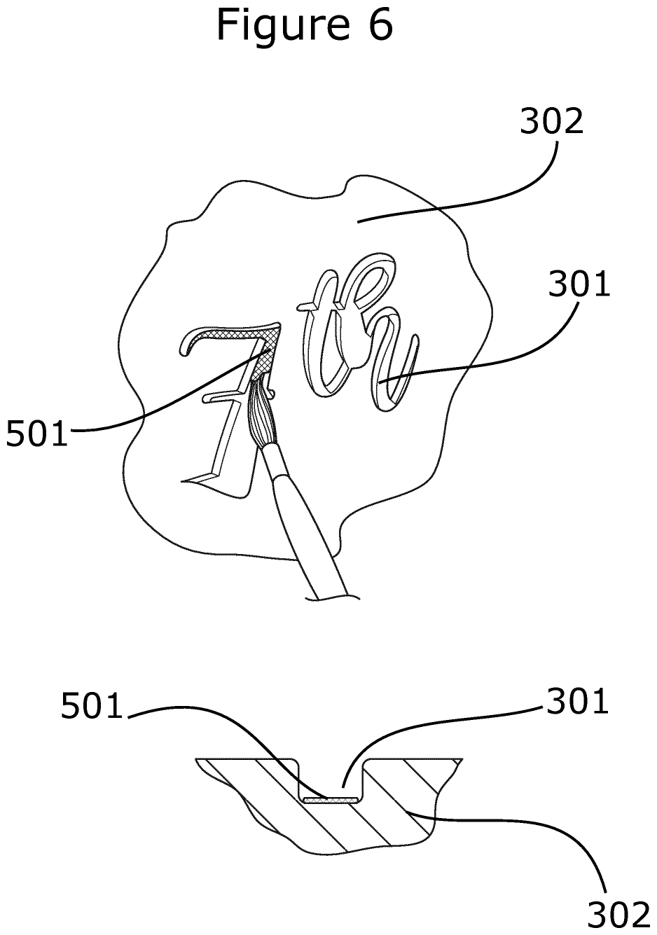

### DETAILED DESCRIPTION OF THE DRAWINGS

The present disclosure describes a confectionary decorating kit.

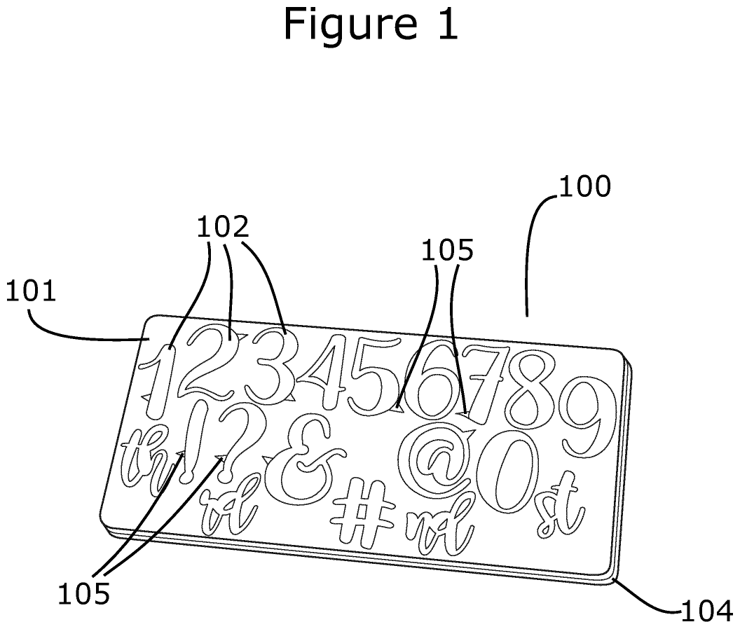

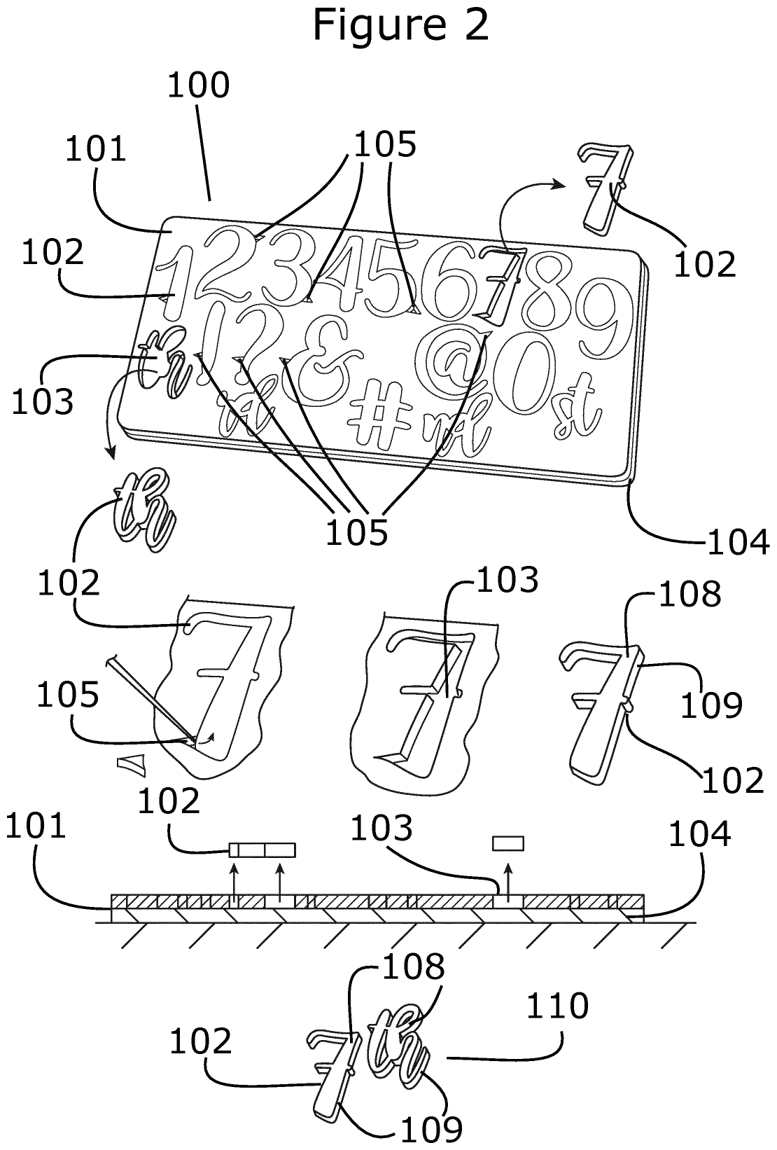

An assembly 100 of the confectionary decorating kit of the present invention is shown in FIG. 1. In this embodiment the block 101 has a plurality of decorative stamp elements 102. The plurality of decorative stamp elements 102 may be cut from the block 101. The block 101 is shown with a backing 104 which in this embodiment is a solid supporting layer. The backing 104 acts to retain the decorative stamp elements 102 within the block 101. The block 101 further comprises lever slots 105 defined therein. The decorative stamp elements 102 are mounted into matching receptacles 103 defined in the block 101 as shown in FIG. 2. The decorative stamp elements 102 are also shown removed from the matching receptacles 103. In this embodiment the plurality of decorative stamp elements 102 comprise alphabetical letters, numerals, and symbols. In this embodiment the block further comprises a backing 104 which is a solid supporting layer attached to and beneath the block 101. Each decorative stamp element 102 is individually removable from its matching receptacle 103 defined in the block 101. Once the decorative stamp elements 102 are removed from their matching receptacles 103 in the block 101 they can be positioned to form a decorative stamp 110 comprising a design formed from the decorative stamp elements 102.

The decorative stamp elements 102 are shown with a first surface which is an imprinting face 108. A side 109 is shown forming a 90° angle with the first surface which is the imprinting surface 108. The angle formed may be from about 85° to about 95°, preferably the angle formed is about 90°. The angle formed means that when the decorative stamp element is used to imprint a design 301 into an item of confectionary 302 the imprinted design 301 is well defined and allows the imprinted design 301 to be further embellished by means such as the application of an edible food dye 501 or other food safe embellishments.

The block 101 may be made from plastics. The block 101 may be made from food grade plastics.

The decorative stamp elements 102 may be cut from the block 101 for example where the block is laser cut to form the plurality of decorative stamp elements 102 and matching receptacles in the block 101.

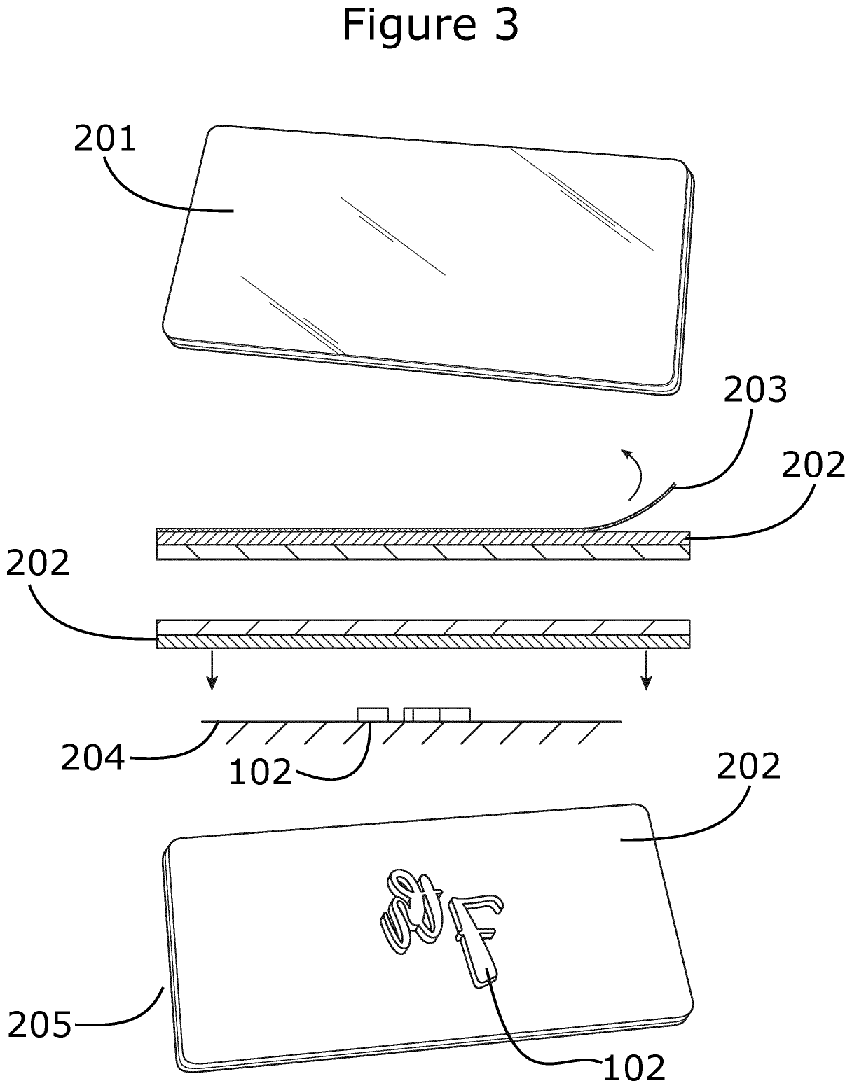

An embodiment of the plate 201 of the present invention is shown in FIG. 3. The plate 201 may be made of plastics. Preferably the plate 201 is made from food grade plastics. The plate 201 comprises a first surface 202. Each decorative stamp element 102 is attachable to the first surface 202 of the plate 201. The first surface 202 is shown in FIG. 3 as covering the entire of plate 201 however the first surface 202 may cover only a portion of the plate 201, for example horizontal or vertical strips, or a plurality of individual contact points. Each decorative stamp element 102 is attachable to the first plate surface 202 by adhesive, magnetic, or suction means. For example each decorative stamp element 102 is attachable to the first plate surface 202 by means of pressure sensitive adhesive. The first surface 202 of the plate 201 may be protected by a covering 203 which prevents contamination of the first surface 202 by dirt or particulate matter. The decorative elements 102 have been removed from their matching receptacles 103 in the block 101 and are shown supported on a retaining surface 204. The first surface 202 of the plate 201 is pressed onto the removed decorative elements 102. The decorative elements 102 are thereby attached to the first surface 202 of the plate 201. A decorative stamp 205 is formed comprising a design formed from the decorative stamp elements 102. Preferably the decorative stamp 205 comprises a mirror image of the design.

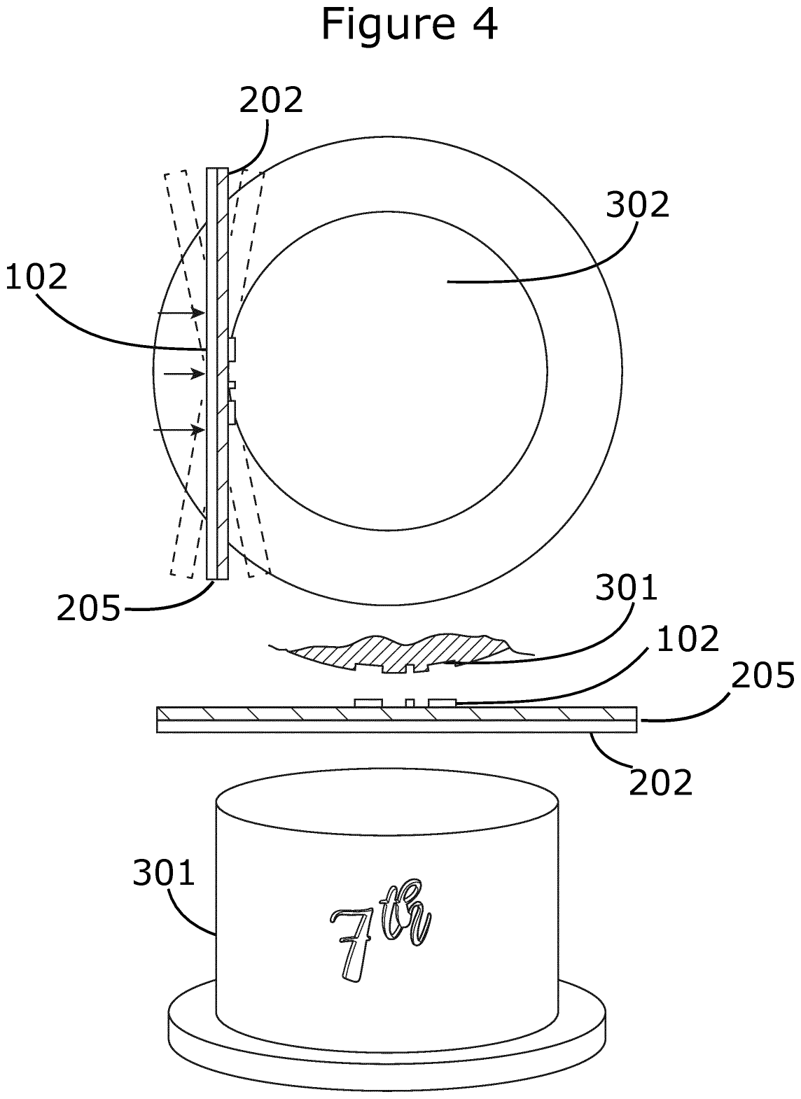

The decorative stamp 205 which is formed by attaching the decorative stamp elements 102 to the first surface 202 of the plate 201 is for use to imprint a design 301 into an item of edible confectionary 302 as shown in FIG. 4. The decorative stamp 205 is pressed onto the edible confectionary 302. As the decorative stamp elements 102 are raised from the first surface 202 of the plate 201 pressing the decorative stamp elements 102 imprints the design onto the confectionary 302. When the decorative stamp 205 comprises a mirror image of the design this means that when the decorative stamp 205 is pressed into the confectionary 302 that the imprinted design 301 is again mirrored to form an unmirrored design.

The decorative stamp elements 102 may be removed from their matching receptacles 103 defined with in the block 101 by inserting a lever into a lever slot 105. The lever slot 105 is shown in FIGS. 1 and 2 as a triangular section cut from the block 101 in addition to the decorative stamp elements 102. The lever slot 105 may be any suitable shape to allow insertion of a lever. The lever slot 105 is an additional recess in the block 101 contiguous with some or all matching receptacles 103 defined in the block 101. The lever slot 105 allows for a lever such as a needle or craft knife to be used to remove the decorative stamp elements 102 from the matching receptacles 103.

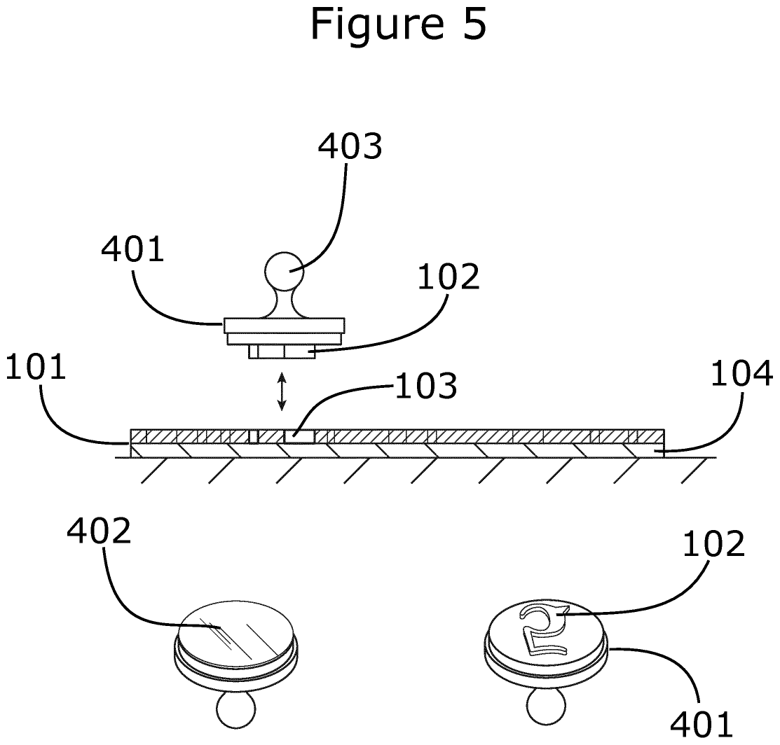

The decorative stamp elements 102 may be removed from their matching receptacles 103 defined with in the block 101 by use of a gripper 401. In the embodiment shown in FIG. 5 the gripper 401 comprises a first gripper surface 402 wherein the first gripper surface 402 is attachable to each decorative stamp element 102. The gripper 401 is attachable to each decorative stamp element 102 by adhesive, magnetic, or suction means, for example by means of pressure sensitive adhesive. The gripper 401 may be pressed on the decorative stamp element 102 while it is housed in its matching receptacle 103 defined within the block 101. The first gripper surface 402 attaches to the decorative stamp element 102. The gripper 401 can then be moved away from the block 101 thereby removing the decorative stamp element 102 from its matching receptacle 103. The gripper 401 may comprise a handle 403 which allows the user to grip the gripper 401 for ease of gripper 401 manipulation. Once the decorative stamp element 102 has been removed from its matching receptacle 103 the decorative stamp element(s) can be arranged to form a decorative stamp 205 for use to imprint a design 301 into an item of edible confectionary 302.

The imprinted design 301 may be further embellished by colouring using edible food dye 501 to enhance the imprinted designs 301 visual appearance and thereby enhancing the overall visual appearance of the confectionary 302 into which the design has been imprinted 301.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A confectionary decorating kit comprising:
a block comprising a plurality of decorative stamp elements and a plurality of receptacles defined in the block wherein each decorative stamp element is mounted into a matching receptacle, and
wherein each decorative stamp element is removable from its matching receptacle.

2. The confectionary decorating kit of claim 1 wherein the kit comprises a backing attached to and beneath the block, for example a supporting layer attached to and beneath the block.

3. The confectionary decorating kit of claim 1 wherein the block is made from plastics.

4. The confectionary decorating kit of claim 1 wherein the block is made from food grade plastics.

5. The confectionary decorating kit of claim 1 wherein the decorative stamp elements are cut from the block, for example where the block is laser cut to form the plurality of decorative stamp elements and matching receptacles in the block.

6. The confectionary decorating kit of claim 1 wherein the block comprises a lever slot defined therein which is contiguous to one of the matching receptacles defined in the block, wherein a lever may be inserted into the lever slot to remove the removable decorative stamp element mounted in the matching receptacle.

7. The confectionary decorating kit of claim 6 wherein the block comprises a plurality of lever slots defined therein wherein each lever slot of the plurality of lever slots is contiguous with an individual matching receptacle.

8. A confectionary decorating kit comprising:
a plate comprising a first plate surface wherein a decorative stamp element is attachable to the first plate surface of the plate to form a decorative stamp comprising a design formed from the decorative stamp elements, and
wherein the decorative stamp is for use to imprint the design into an item of edible confectionary.

9. The confectionary decorating kit of claim 8 wherein the plate is made from plastics.

10. The confectionary decorating kit of claim 8 wherein the plate is made from food grade plastics.

11. The confectionary decorating kit of claim 8 wherein the plate is rigid.

12. The confectionary decorating kit of claim 8 wherein the plate comprises a raised gripping portion or a handle.

13. The confectionary decorating kit of claim 8 wherein each decorative stamp element is attachable to the first plate surface by adhesive, magnetic, or suction means.

14. The confectionary decorating kit of claim 8 wherein each decorative stamp element is attachable to the first plate surface by means of pressure sensitive adhesive.

15. (canceled)

16. (canceled)

17. (canceled)

18. (canceled)

19. (canceled)

20. A confectionary decorating kit comprising a combination of:
a confectionary decorating kit comprising
a block comprising a plurality of decorative stamp elements and a plurality of receptacles defined in the block wherein each decorative stamp element is mounted into a matching receptacle, wherein each decorative stamp element is removable from its matching receptacle;
and
a confectionary decorating kit comprising a plate comprising a first plate surface wherein a decorative stamp element is attachable to the first plate surface of the plate to form a decorative stamp comprising a design formed from the decorative stamp elements, wherein the decorative stamp is for use to imprint the design into an item of edible confectionary.

21. (canceled)

22. The confectionary decorating kit of claim 1 wherein the decorative stamp elements are rigid.

23. The confectionary decorating kit of claim 1 wherein each decorative stamp element comprises:
a first surface which is an imprinting face,
a side which forms an angle of from 85° to 95°, preferably 90°, with the first surface.

24. The confectionary decorating kit of claim 1 wherein each decorative stamp element is in the shape of an alphabetical letter, a number, or a geometric shape.

25. The confectionary decorating kit of claim 1 wherein the confectionary is a baked good such as a cake, a bun, a pastry, a tart, a cookie or a pie.

26. The confectionary decorating kit of claim 1 wherein the confectionary comprises an outer layer of icing or frosting or ganache.

27. (canceled)

28. (canceled)

29. (canceled)

30. (canceled)

31. (canceled)

32. (canceled)

33. (canceled)

34. (canceled)

35. (canceled)

36. (canceled)
